(19) United States
(12) Patent Application Publication
(10) Pub. No.: US 2008/0107959 A1
(43) Pub. Date: May 8, 2008

(54) Composite Sheet, Manufacturing Method Thereof, And Electric And Electronic Component Using The Same

(75) Inventors: Hitoshi Ishino, Tokyo (JP); Shinji Naruse, Tokyo (JP); Kazuo Izaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DUPONT TEIJIN ADVANCED PAPERS (JAPAN) LTD., CHIYODA-KU, TOKYO (JP)

(21) Appl. No.: 11/885,156

(22) PCT Filed: Mar. 22, 2006
(86) PCT No.: PCT/JP06/06376

§ 371 Date: Aug. 27, 2007

(30) Foreign Application Priority Data
Mar. 23, 2005 (JP) 2005-83498

(51) Int. Cl. H01M 2/16

(52) U.S. Cl. 429/129

(57) ABSTRACT

A composite sheet having a layer structure of at least two or more layers in which a porous sheet layer of a thermoplastic polymer having at least a melting point of not higher than 200° C. and a nonwoven fabric-like sheet layer containing at least one component of a fibrid, a short fiber or a fibrillated pulp of an organic compound not substantially having a stable melting point are stacked, the composite sheet being able to be used for condensers, capacitors and batteries, exhibiting a sufficient effect against high energy and large outputs and being suitable as a separator for secondary batteries or capacitors having both shutdown function and high-temperature shape stability.

### TECHNICAL FIELD

The present invention relates to, for example, a separator partitioning a positive electrode material and a negative electrode material from each other in a secondary battery and passing an electrolyte or an ion in an electrolytic liquid therethrough and to an electric and electronic component using the same, such as batteries and capacitors. In particular, the invention relates to a separator configured of a sheet made of plural organic compounds having different thermal characteristics from each other, which is useful as a separator of a secondary battery using, as a current carrier, an ion of an alkali metal such as lithium and sodium.

### BACKGROUND ART

At the present time when secondary batteries and capacitors are used as a power source of mobile electronic appliances or the like and are also partially put into practical use as a powder source for electric cars and hybrid cars, mounting of various batteries on these electronic appliances and electric cars or hybrid cars is being studied. Above all, secondary batteries or capacitors with high performance which are small in size and light in weight, high in energy density and endurable against long-term storage are keenly expected, and it is the present state that their wide applications are contemplated. A structure of a representative lithium secondary battery is mainly configured to include a positive electrode utilizing, as a positive electrode active substance, a composite oxide with a transition metal containing an Li ion, a negative electrode using, as a negative electrode active substance, a carbon based material capable of occluding and separating an Li ion, a separator inserted between the positive and negative electrodes, and an electrolytic liquid made of an electrolyte such as LiPF₆ and LiBF₄ and an organic solvent. Furthermore, the foregoing power generation elements are accommodated in a battery container and sealed by a positive electrode terminal and a negative electrode terminal connected to the positive electrode and the negative electrode, respectively and a gasket. A collector using a prescribed metal is pressure formed in a stripe state with respect to each of the positive electrode and the negative electrode.

In that case, examples of general characteristics which are required for the separator are as follows.

(1) In addition to the function to partition the electrode materials from each other, the separator has a function to break a battery circuit when a large current flows due to a short circuit in each part (shutdown characteristic).

(2) In the state of holding the electrolytic liquid, the separator has good electrolyte or ion permeability.

(3) The separator has electrical insulation properties.

(4) The separator is chemically stable against the electrolytic liquid and simultaneously electrochemically stable.

(5) The separator has mechanical strength, can be made thin in thickness, is easily wettable against the electrolytic liquid and has good maintenance of the electrolytic liquid.

In particular, the shutdown characteristic is extremely important in a sense of preventing a phenomenon in which an excess current flows into the battery, whereby chemical reaction proceeds abruptly and the battery circuit runs out of control.

Porous sheets fabricated by using a polyolefin based polymer such as polyethylene (PE) and polypropylene (PP) have hitherto been widely used as the foregoing separators. This porous sheet is manufactured by 1) a method in which a solvent having a plasticization action and a polymer are kneaded and fabricated, and the solvent is then extracted and rinsed (this method being generally called as a wet method); or 2) a method in which a molten polymer is subjected to extrusion molding to form a sheet, which is then stretched to generate cracks, thereby forming fine pores (this method being generally called as a dry method). The thus manufactured separator is used as a single layer or plural layers, or taken up in a roll state and used within the battery.

By choosing polyethylene (PE) having a melting temperature of 130° C. or polypropylene (PP) having a melting temperature of 170° C. which are employed as materials of the separator, the separator causes heat shrinkage or melting due to the heat generation generated when an excessive current flows within the battery due to an external short circuit as described above or a temperature rise due to an external factor, whereby a number of fine pores are plugged, and therefore, the separator plays a role for breaking the battery circuit. From the viewpoint that it is safer that a number of fine pores are plugged at a lower temperature, with respect to the material, the separator is mainly composed of polyethylene (PE).

As a matter of course, for the purpose of protecting the battery circuit, in addition to the separator, it is possible to incorporate a safety device function such as PTC into an external circuit. However, in secondary batteries of applications for electric cars and hybrid cars whose large development is expected in the future, when a possibility that the external safety device circuit is broken due to the impact during a car crash, etc. is taken into consideration together, it is thought that with respect to the safety, the separator having a shutdown function is necessary and essential from the viewpoint of fool proof. Furthermore, in the case where a temperature rise continues after shutdown, in addition to this shutdown characteristic, a shape retention power of the separator is an important element. That is, in the case where a polymer having a melting point in the temperature range of from 120 to 170° C., for example, polyethylene (PE) and polypropylene (PP) is employed, if the temperature rise continues even after the shutdown due to some factor, the separator itself melts, and as a result, there is pointed out a problem that the current shutdown function disappears substantially completely. If the shape of the separator is lost too fast, a short circuit of electrode is caused, resulting in creating a dangerous state.

In order to solve the foregoing problems, with respect to the material of the separator of a secondary battery, there are made some proposals regarding a multi-component material made of a combination of a low-melting material and a high-melting material, in which the low-melting material is brought with a shutdown function, whereas the high-melting material is brought with a shape retention function at a high temperature.

(1) For example, JP-A-61-232560 describes a composite fiber nonwoven fabric having a core/sheath structure.

(2) JP-A-63-308866 discloses a microporous film formed of plural kinds of materials having a different melting point from each other.

(3) On the other hand, JP-A-1-258358 proposes a structure in which a microporous film made of a low-melting resin and a nonwoven fabric made of a polymer having a higher melting point than the former are stacked.

However, the melting point of the high-melting compounds disclosed therein is 270° C. at most, and Tg (glass transition temperature) which is a temperature as a standard at which a thermal motion of polymers starts is not higher than 100° C. Accordingly, in the case where a sudden and local temperature rise is caused, it is not said that the separator shape and the short circuit preventing function are completely held. In particular, in the case of polymers configuring a usual separator, since a thermal conductivity is generally low, the possibility of local temperature rise and melting cannot be negated.

(4) Also, a separator in which a polyethylene (PE) porous film and a polypropylene (PP) porous film are stacked is put into practical use. However, even in that case, a problem that the separator is thermally instable is not substantially solved yet.

(5) Besides, it is proposed to use a thermally stable aromatic polyamide (hereinafter referred to as “aramid”) as a separator component (see JP-A-5-33005, JP-A-7-37571 and JP-A-7-78608). These are concerned with the use of aramid fiber/pulp with excellent heat resistance but do not describe that a shutdown function is imparted.

(6) JP-A-9-27311 discloses a nonwoven fabric for battery separators containing at least a fibrillated organic fiber. It is described that this nonwoven fabric may contain a low-melting fiber such as polyethylene fibers and poly-propylene fibers. However, in the case where the low-melting component is in a fibrous state, even if the nonwoven fabric is melted, an area capable of being covered is not large, and therefore, it is hard to say that the previously described shutdown function is sufficient.

### DISCLOSURE OF THE INVENTION

It is the state that a sheet-like material for separators of batteries and capacitors, especially secondary batteries having both shutdown function and high-temperature shape stability as aimed in the invention was not provided at all. In view of contemplating to spread a lithium secondary battery to industrial applications in the future, a battery separator having such a safety device function is eagerly expected. Then, an object of the invention is to provide a separator having excellent shutdown function and shape stability at high temperatures as important characteristics regarding the safety of a secondary battery. Another object of the invention is to provide an electric and electronic component such as batteries and capacitors, the stability of which is improved by providing such a separator.

Under such circumstances, in order to develop a material for separators provided with sure shutdown function and high-temperature shape stability, the present inventors made extensive and intensive investigations. As a result, they have reached the invention.

That is, a composite sheet according to a first invention of the present application is characterized by having a layer structure of at least two or more layers in which a porous sheet layer of a thermoplastic polymer having at least a melting point of not higher than 200° C. and a nonwoven fabric-like sheet layer containing at least one component of a fibrid, a short fiber and a fibrillated pulp of an organic compound not substantially having a stable melting point are stacked.

A composite sheet according to a second invention of the present application is characterized in that in the composite sheet according to the foregoing first invention, the foregoing organic compound does not substantially have a stable melting point at not higher than 200° C.

A composite sheet according to a third invention of the present application is characterized in that in the composite sheet according to the foregoing second invention, the foregoing organic compound is an aramid.

A composite sheet according to a fourth invention of the present application is characterized in that in the composite sheet according to any one of the foregoing first to third inventions, the foregoing thermoplastic polymer is a polyolefin.

A composite sheet according to a fifth invention of the present application is characterized in that in the composite sheet according to any one of the foregoing first to fourth inventions, its air permeability measured by a Gurley type air permeability measurement method is not more than 1,000 sec/100 cm³.

An electric and electronic component according to a sixth invention of the present application is characterized in that the composite sheet according to any one of the foregoing first to fifth inventions is used as a separator between conductive members.

That is, the major technical thought of the invention is concerned with the matter that a battery separator is formed by laminating a layer made of a porous sheet of a thermoplastic polymer having a melting point of not higher than 200° C. and a layer made of a nonwoven fabric-like sheet containing at least one component of a fibrid, a short fiber or a fibrillated pulp of an organic compound not substantially having a stable melting point.

### BEST MODES FOR CARRYING OUT THE INVENTION

The invention is hereunder described in detail.

[Melting Point]

The melting point of the polymer in the invention is defined by a thermal measurement method such as DSC (differential scanning calorimetry) and DTA (differential thermal analysis). In general, a polymer exhibits a wide melting behavior reflecting the matter that it contains non-single molecular weight components, a difference in a degree of crystallization and so on. The melting point as referred to in the invention is defined in terms of a temperature corresponding to an endothermic peak by DSC analysis.

[Thermoplastic Polymer Having a Melting Point of not Higher than 200° C.]

Though the thermoplastic polymer having a melting point of not higher than 200° C. which is used in the invention is not particularly limited, polyolefins are enumerated as one example. Examples of the polyolefin include polyethylene, polypropylene, polybutene, polymethylpentene, and copolymers thereof. However, it should not be construed that the invention is limited thereto. Of these, polyethylene and polypropylene are preferable. With respect to these polymers, in addition to polymers containing a linear structure, ones having a structure, for example, a branched chain and a crosslinking site can also be utilized.

In the composite sheet of the invention, when such a thermoplastic polymer is heated in the vicinity of the melting point, it melts, whereby a shutdown function is revealed.

[Organic Compound not Substantially Having a Stable Melting Point]

As the organic compound not substantially having a stable melting point which is used in the invention, the following can be utilized.

(1) An organic compound in which when heated and increased in temperature, a crosslinking reaction proceeds so that its melting point increases to a decomposition temperature of the compound or higher.

(2) An organic compound in which a melting point and a decomposition temperature thereof are closed to each other so that thermal decomposition of the compound takes place in parallel to melting.

(3) An organic compound which is free from a melting characteristic and therefore, does not have a melting point.

In the invention, of these organic compounds, organic compounds not substantially having a stable melting point at not higher than 200° C. are preferable. Though such an organic compound which is used in the invention is not particularly limited, examples thereof include aramids, polyimides, polyamide-imides, polyacrylonitrile, polyarylates (wholly aromatic polyesters), cellulose, polyazomethine, polyacetylene, and polypyrrole, with aramides being especially preferable.

As the shape of the foregoing organic compound, though papers, nonwoven fabrics, thin leaf type materials, etc. which are made of a fiber, a fibrillated fiber or a fibrid may be thought, it is not particularly limited so far as it contains at least the foregoing organic compound as one component and has sufficient ion permeability as a separator.

Here, what it contains at least the foregoing organic compound as one component means that the subject component is contained in an amount of from 10 to 100% by weight, and preferably from 30 to 100% by weight as a component of papers, nonwoven fabrics, thin leaf type materials, etc.

Aramid thin leaf type materials described in JP-A-2003-064595 are enumerated as one example, but it should not be construed that the invention is limited thereto.

[Composite Sheet Having a Layer Structure of at Least Two Or More Layers in which the Foregoing Thermoplastic Polymer Layer and the Foregoing Organic Compound Layer are Stacked]

The composite sheet of the invention as referred to herein has a layer structure of at least two or more layers in which the foregoing thermoplastic polymer layer and the foregoing organic compound layer are stacked, and in the case where it is used as a separator, its thickness is preferably in the range of from 5 μm to 100 m, more preferably from 5 μm to 50 μm, and further preferably from 5 μm to 30 μm. In the case where the thickness is less than 5 μm, a mechanical characteristic is reduced, thereby easily causing problems in shape retention as the separator and handling such as conveyance in the manufacturing steps; whereas in the case where it exceeds 100 μm, an increase in internal resistivity is easily brought, and above all, small-sized electric and electronic components with high performance are hardly manufactured.

A thickness of the porous sheet of the thermoplastic polymer configuring the composite sheet is preferably not more than 8 μm.

Furthermore, in the case where the composite sheet of the invention is used as a separator, its basis weight is preferably within the range of from 5 to 1,000 g/m². In the case where the basis weight is less than 5 g/m², because of insufficient mechanical strength, breakage easily occurs in handing of every kind in manufacturing steps of components such as an impregnation treatment of an electrolyte and take-up. On the other hand, in a composite sheet having a basis weight larger than 1,000 g/m², an increase in thickness or a reduction in impregnation and penetration of an electrolyte is liable to generate.

A density of the composite sheet of the invention is a value calculated from (basis weight)/(thickness) and can be usually made to fall within the range of from 0.1 to 1.2 g/m³.

The composite sheet of the invention preferably has an air permeability measured by a Gurley type air permeability measurement method of not more than 1,000 sec/100 cm³. The Gurley type air permeability as referred to herein is a time expressed in terms of a second unit, which is required for air of 100 cm³ to flow out through a sample resulting from interposition between clamping plates having a circular hole having an outer diameter of 28.6 mm. In the case where a composite sheet having a Gurley type air permeability exceeding 1,000 seconds/100 cm³ is used upon impregnation and penetration of an electrolyte in an aramid thin leaf type material, there is a possibility that sufficient penetration and filling cannot be achieved.

With respect to a manufacturing method for obtaining the composite sheet of the invention, a layer-to-layer bonding method is not particularly limited so far as the porous sheet layer and the nonwoven fabric-like sheet layer forming a composite have a stratiform structure; and it is sufficient so far as bonding is performed sufficiently for handling in incorporating it as a separator into an electric and electronic component such as batteries and capacitors.

In general, the nonwoven fabric-like sheet can be manufactured by a method in which after mixing the foregoing organic compound, the mixture is formed into a sheet. Concretely, for example, a method in which after dry blending the foregoing organic compound, a sheet is formed by utilizing an air stream; and a method in which after dispersing and mixing the organic compound in a liquid medium, the mixture is discharged onto a liquid-permeable support, for example, a net or a belt to form a sheet, and the liquid is removed to achieve drying are applicable. Of these, a so-called wet paper forming method using water as a medium is preferably chosen.

In the wet paper forming method, a method in which an aqueous slurry containing at least a single organic compound or a mixture thereof is sent to a paper forming machine and dispersed, followed by dehydration, water squeezing and drying operations to take up it as a sheet is general. As the paper forming machine, a fourdrinier paper machine, a cylinder paper machine, an inclined type paper machine, a combination paper machine composed of a combination thereof, and the like can be utilized. In the case of manufacture by a combination paper machine, it is possible to obtain a composite sheet made of plural paper layers by forming slurries having a different blending ratio from each other into a sheet and unifying them. In paper forming, additives such as a dispersibility improving agent, an anti-foaming agent, and a paper strength agent can be used as the need arises. In addition to the above, other fibrous or pulp-like components (for example, organic fibers such as polyolefin fibers, polyolefin pulps, polyphenylene sulfide fibers, polyetheretherketone fibers, cellulose based fibers, cellulose based pulps, PVA based fibers, polyester fibers, acrylate fibers, liquid crystal polyester fibers, and polyethylene naphthalate fibers; and inorganic fibers such as glass fibers, rock wool, asbestos, and boron fibers) can also be added.

Also, it is possible to prepare a composite sheet by superimposing one or more foregoing porous sheets of a thermoplastic polymer and one or more nonwoven fabric-like sheets containing at least one component of a fibrid, a short fiber or a fibrillated pulp of an organic compound and compression bonding them in a heated state between one pair of flat plates or metal-made rolls. With respect to the condition of the thermocompression bonding, for example, in the case of using metal-made rolls, though a condition at a temperature in the range of from 30 to 150° C. and a linear pressure in the range of from 30 to 400 kg/cm can be enumerated, it should not be construed that the invention is limited thereto. In the case of performing a heating operation, since when the thermoplastic polymer layer causes thermal shrinkage or melting upon heating to plug the pores, the ion permeability as a separator is hindered, it is especially preferable that only pressurization is carried out at a temperature of at least 50° C. lower than the melting point of the thermoplastic polymer. In particular, in the pressurization operation, plural composite sheets can be stacked, too. The foregoing thermocompression workings can also be carried out several times in an arbitrary order.

Not only the thus obtained composite sheet has both an efficient shutdown function at not higher than 200° C. as caused due to the thermoplastic polymer and a high-temperature shape stabilization function on the basis of the organic compound not substantially having a stable melting point, but also it is able to solve conventional drawbacks such as easy tear due to a shortage of mechanical strength of each of two kinds of separators and difficulty in handling in individually forming them. Accordingly, the thus obtained composite sheet can be suitably used as a non-aqueous electrolytic liquid battery supposing industrial applications, especially a lithium secondary battery. By installing such a composite sheet, it is possible to largely enhance safety of a battery. Such a battery can be applied to conventional battery applications for electric appliances such as mobile phones and personal computers but also as energy storage and generation devices of a large-sized appliance such as electric cars.

[Internal Resistivity Value]

In the invention, an internal resistivity value expressed by the following expression (1) is employed as a characteristic to show electrolyte or ion permeability in a state of holding an electrolytic liquid.
(Internal resistivity value)=(Electric conductivity of an electrolytic liquid)/(Electric conductivity when an electrolytic liquid is poured into a separator)×(Thickness of a Separator) Expression (1)

The electrolytic liquid as referred to herein means a liquid having an electrolyte dissolved in a solvent.

In the invention, the solvent and the electrolyte used in the electrolytic liquid, the concentration of the electrolyte, and the like are not particularly limited. Examples of the solvent include ethylene carbonate, propylene carbonate, dimethyl carbonate, diethyl carbonate, ethylmethyl carbonate, butylene carbonate, glutaronitrile, adiponitrile, acetonitrile, methoxyacetonitrile, 3-methoxypropionitrile, γ-butyrolactone, γ-valerolactone, sulforane, 3-methylsulforane, nitroethane, nitromethane, trimethyl phosphate, N-methyloxazolidinone, N,N-dimethylformamide, N-methylpyrrolidone, dimethyl sulfoxide, N,N′-dimethylimidazolidinone, amidine, water, and mixtures thereof.

Also, examples of the electrolyte include combinations of the following cation and anion as ionic substances.

1) Cation:

A quaternary ammonium ion, a quaternary phosphonium ion, a lithium ion, a sodium ion, an ammonium ion, a hydrogen ion, mixtures thereof, etc.

2) Anion:

A perchloric acid ion, a borofluoride ion, a hexafluorophosphoric acid ion, a sulfuric acid ion, a hydroxide ion, mixtures thereof, etc.

Also, the (electric conductivity when an electrolytic liquid is poured into a separator) as referred to in the invention means an electric conductivity calculated from an alternating current impedance measured upon interposing a separator in a state that the foregoing electrolytic liquid is poured thereinto by two electrodes.

Though a measuring frequency of the alternating current impedance is not particularly limited, it is preferably from 1 kHz to 100 kHz.

### EXAMPLES

Embodiments (Examples) of the invention are hereunder described in detail.

[Measurement Methods]

(1) Measurement of basis weight and thickness of sheet:

This measurement was carried out in conformity to JIS C2111.

(2) Gurley Air Permeability:

An air permeability measured by using an Oken type air permeability meter was reduced into a Gurley type air permeability. With respect to a series of sheets, it may be said that the shorter this time, the more porous the sheet is.

(3) Measurement of Electric Conductivity:

A separator was cut out into a circle having a diameter of 20 mm and interposed by two SUS electrodes, and an electric conductivity was calculated from an alternating current impedance at 60 kHz.

At that time, the measuring temperature was set up at 25° C. For the measurement, 1M lithium boroflubride ethylene carbonate/propylene carbonate (1/1 weight ratio) was used as an electrolytic liquid.

[Preparation of Raw Materials]

A fibrid of polymetaphenylene isophthalamide manufactured by Du Pont (NOMEX (registered trademark) fibrid) was treated by a disintegrator and a beater, thereby preparing a fibrid having a weight average fiber length of 0.9 mm.

On the one side, a meta-aramid fiber manufactured by Teijin Techno Products Limited (TEIJINCONEX registered trademark)) with a fineness of 0.8 deniers was cut into a length of 5 mm; a para-aramid fiber manufactured by Teijin Techno Products Limited (TECHNORA (registered trademark)) with a fineness of 0.55 deniers was cut into a length of 3 mm; and a para-aramid pulp manufactured by Teijin Twaron B. V. (TWARON (registered trademark)) was adjusted so as to have a specific surface area of 14 m²/g and a freeness of 85 mL, thereby preparing raw materials for paper forming.

On the other hand, a polyethylene pulp (SWP (registered trademark) E620 manufactured by Mitsui Chemicals, Inc., melting point: 135° C.) was dispersed in water by using a mixer and adjusted so as to have a Canadian standard freeness of 300 mL.

[Manufacture of Aramid Sheet]

The prepared aramid fibrid and the meta-aramid short fiber and the para-aramid short fiber and the fibrillated aramid were respectively dispersed in water, thereby preparing a slurry. This slurry was mixed with the aramid fibrid, the aramid short fiber, the TWARON pulp and the polyethylene pulp in a blending ratio as shown in Table 1, from which was then prepared in a sheet-like material by a TAPPI type handmade paper forming machine (cross-sectional area: 325 cm²) (Examples 1, 2 and 3, respectively). Next, with respect to Example 1, this was subjected to hot pressing at a temperature of 330° C. and a linear pressure of 300 kg/cm by metal-made calender rolls, thereby obtaining an aramid sheet.

[Manufacture of Composite Sheet]

The foregoing aramid sheet and a polyethylene porous film manufactured by Teijin Solufill Limited (thickness: 7.1 microns, porosity: 56%, Gurley: 93 sec/100 mL) were superimposed and subjected to hot pressing at a temperature of 60° C. and a linear pressure of 100 kg/cm by metal-made calender rolls, thereby obtaining a composite sheet.

Major characteristic values and Gurley type air permeability after the thermal treatment of each of the thus obtained composite sheets are shown in Table 1. The heat treatment was carried out by using a hot-air oven, and after holding at each temperature for 10 minutes, the resulting composite sheet was cooled and measured for the air permeability.

It is understood from Example 1 that by forming a composite sheet, the air permeability of the sheet material prepared in the vicinity of 145° C. increases. Furthermore, when the heating temperature was increased, the foregoing polyethylene porous film layer completely melted and shrunk, whereas the aramid sheet did not shrink, thereby holding the separator shape.

### Comparative Examples 1 and 2

The aramid sheet prepared in the Examples and the foregoing polyethylene porous film were each heat treated in the same manner as in the Examples. The obtained characteristics are shown in Tables 2 and 3.

TABLE 1

| Structure | Characteristics | | Unit | Example 1 | Example 2 | Example 3 |
|---|---|---|---|---|---|---|
| Aramid | Raw material composition | | % by weight | | | |
| sheet | Aramid fibrid | | | 2 | | |
| | Meta aramid fiber | | | 53 | 30 | |
| | Para aramid fiber | | | | | 30 |
| | Aramid pulp | | | 45 | | |
| | Polyethylene pulp | | | | 70 | 70 |
| | Basis weight | | g/m² | 19 | 12 | 12 |
| | Thickness | | μm | 39 | 53 | 56 |
| | Density | | g/cm³ | 0.49 | 0.23 | 0.21 |
| | Air permeability | | sec/100 cm³ | 2.0 | ≦0.5 | ≦0.5 |
| Polyethylene | Raw material composition | | % by weight | | | |
| porous film | Polyethylene | | | 100 | 100 | 100 |
| | Basis weight | | g/m² | 3 | 3 | 3 |
| | Thickness | | μm | 7 | 7 | 7 |
| | Density | | g/cm³ | 0.43 | 0.43 | 0.43 |
| | Air permeability | | sec/100 cm³ | 138 | 138 | 138 |
| Composite | Composition | | Number of | | | |
| sheet | | | layer | | | |
| | Foregoing aramid sheet | | | 1 | 1 | 1 |
| | Foregoing polyethylene | | | 1 | 1 | 1 |
| | porous film | | | | | |
| | Basis weight | | g/m² | 22 | 15 | 15 |
| | Thickness | | μm | 29 | 24 | 24 |
| | Density | | g/cm³ | 0.76 | 0.63 | 0.63 |
| | Air | Initial value | sec/100 cm³ | 300 | 493 | 417 |
| | permeability | 120° C. | | 290 | 480 | 400 |
| | | 125° C. | | 275 | 460 | 390 |
| | | 130° C. | | 305 | 500 | 420 |
| | | 135° C. | | 262 | 490 | 410 |
| | | 140° C. | | 550 | 700 | 650 |
| | | 145° C. | | about | about | about |
| | | | | 20,000 | 20,000 | 20,000 |
| | | 150° C. | | about | about | about |
| | | | | 20,000 | 20,000 | 20,000 |
| | | 155° C. | | 3.4 | about | about |
| | | | | | 20,000 | 20,000 |
| | Appearance | 155° C. | | Shape | Lowly | Lowly |
| | | | | held | shrunk | shrunk |

| | | | | |
|---|---|---|---|---|
| Internal resistivity | μm | 500 | 740 | 636 |

TABLE 2

| | | | | Comparative |
|---|---|---|---|---|
| Structure | Characteristics | | Unit | Example 1 |
| Aramid | Raw material composition | | % by weight | |
| sheet | Aramid fibrid | | | 2 |
| | Aramid short fiber | | | 53 |
| | Aramid pulp | | | 45 |
| | Basis weight | | g/m² | 19 |
| | Thickness | | μm | 39 |
| | Density | | g/cm³ | 0.49 |
| | Air permeability | Initial value | sec/100 cm³ | 2.0 |
| | | 120° C. | | 2.0 |
| | | 125° C. | | 2.0 |
| | | 130° C. | | 1.9 |
| | | 135° C. | | 2.0 |
| | | 140° C. | | 2.0 |
| | | 145° C. | | 2.0 |
| | | 150° C. | | 2.0 |
| | | 155° C. | | 2.0 |
| | Appearance | 155° C. | | Not changed |

TABLE 3

| | | | | Comparative |
|---|---|---|---|---|
| Structure | Characteristics | | Unit | Example 2 |
| Polyethylene | Raw material composition | | % by weight | |
| porous film | Polyethylene | | | 100 |
| | Basis weight | | g/m² | 3 |
| | Thickness | | μm | 7 |
| | Density | | g/cm³ | 0.43 |
| | Air | Initial value | sec/100 cm³ | 138 |
| | permeability | 120° C. | | 148 |
| | | 125° C. | | 157 |
| | | 130° C. | | 161 |
| | | 135° C. | | 174 |
| | | 140° C. | | 339 |
| | | 145° C. | | about 30,000 |
| | | 150° C. | | about 30,000 |
| | | 155° C. | | Measurement |
| | | | | impossible |
| | Appearance | 155° C. | | Largely |
| | | | | thermally |
| | | | | shrunk |

In the aramid sheet (Comparative Example 1), the air permeability did not substantially changed, and it was thus understood that a shutdown function at the temperature rise is not obtained. On the other hand, the porous film made of only polyethylene (Comparative Example 2) exhibited remarkable thermal shrinkage at 155° C., and this film could not substantially hold the shape as a separator. Accordingly, it has become clear that it is effective to use the foregoing composite sheet made of two layers for the purpose of obtaining a battery separator which is excellent in shutdown function and shape stability at high temperatures as important characteristics regarding the safety of a secondary battery.

### INDUSTRIAL APPLICABILITY

Since such a composite sheet according to the invention is configured of a thermoplastic polymer excellent in shutdown function due to thermal shrinkage and melting and an aramid exhibiting excellent characteristics in high-temperature shape retention function, it is possible to provide a battery separator which not only has more excellent shutdown function and high shape retention power but also has characteristics required as a separator of a secondary battery. Electric and electronic components having this separator installed therein, for example, lithium secondary batteries and electric double layer capacitors can be utilized as a power source of electric appliances such as mobile phones and computers, electric cars and hybrid cards, and so on.

1. A composite sheet, which is characterized by having a layer structure of at least two or more layers in which a porous sheet layer of a thermoplastic polymer having at least a melting point of not higher than 200° C. and a nonwoven fabric-like sheet layer containing at least one component of a fibrid, a short fiber and a fibrillated pulp of an organic compound not substantially having a stable melting point are stacked.

2. The composite sheet according to claim 1, which is characterized in that the organic compound does not substantially have a stable melting point at not higher than 200° C.

3. The composite sheet according to claim 1, which is characterized in that the organic compound is an aromatic polyamide.

4. The composite sheet according to claim 1, which is characterized in that the thermoplastic polymer is a polyolefin.

5. The composite sheet according to claim 1, which is characterized by having an air permeability measured by a Gurley type air permeability measurement method of not more than 1,000 sec/100 cm³.

6. An electric and electronic component, which is characterized in that the composite sheet according to claim 1 is used as a separator between conductive members.

7. The composite sheet according to claim 2, which is characterized in that the organic compound is an aromatic polyamide.

8. The composite sheet according to claim 2, which is characterized in that the thermoplastic polymer is a polyolefin.

9. The composite sheet according to claim 2, which is characterized by having an air permeability measured by a Gurley type air permeability measurement method of not more than 1,000 sec/100 cm³.

10. An electric and electronic component, which is characterized in that the composite sheet according to claim 2 is used as a separator between conductive members.
